(19) United States
(12) Patent Application Publication
(10) Pub. No.: US 2011/0191183 A1
(43) Pub. Date: Aug. 4, 2011

(54) METHOD AND APPARATUS FOR MANAGING PREPAID USER INITIATED ADVERTISER CONTENT PRINTING OPERATION AT A CUSTOMER SITE

(75) Inventor: Brent Rodney Jones, Sherwood, OR (US)

(73) Assignee: XEROX CORPORATION, Norwalk, CT (US)

(21) Appl. No.: 12/696,092

(22) Filed: Jan. 29, 2010

(51) Int. Cl. G06Q 30/00; G06Q 10/00

(52) U.S. Cl. 705/14.55

(57) ABSTRACT

Document processing device account management systems and methods are disclosed for managing prepaid usage document processing devices to allow user initiated advertiser content printing operation at a customer site with no cost to the user, and to facilitate making reservations and payment in advance for reserved services.

### BACKGROUND

The present disclosure is generally related to operation and management of document processing devices such as printers, scanners, copiers, combination scanner-printer-copier machines, and the like in accordance with customer accounts.

The disclosures of the following U.S. patents and patent Applications are hereby incorporated by reference in their entireties: U.S. patent application Ser. No. 12/364,224, entitled “METHOD AND SYSTEM FOR TRANSMITTING PROOF OF PAYMENT FOR “PAY-AS-YOU-GO” MULTI-FUNCTION DEVICES”, and filed Feb. 2, 2009; U.S. patent application Ser. No. 12/424,820, entitled “METHOD AND SYSTEM FOR PROVIDING CONTRACT-FREE ‘PAY-AS-YOU-GO’ OPTIONS FOR UTILIZATION OF MULTI-FUNCTION DEVICES”, and filed Apr. 16, 2009; U.S. patent application Ser. No. 12/424,858, entitled “SYSTEM AND METHOD FOR SELECTIVELY CONTROLLING THE USE OF FUNTIONALITY IN ONE OR MORE MULTIFUNCTION DEVICES AND SUBSIDIZING THEIR USE THROUGH ADVERTISEMENTS”, and filed Apr. 16, 2009; U.S. Pat. No. 6,940,613, entitled “SYSTEM FOR MANAGING REPLACEABLE MODULES IN A DIGITAL PRINTING APPARATUS”, and issued Sep. 6, 2005; U.S. Pat. No. 6,076,076, entitled “PREPAID PRINT CARD SYSTEM AND METHOD”, and issued Jun. 13, 2000; U.S. Pat. No. 5,563,999, entitled “FORMS AUTOMATION SYSTEM”, and issued Oct. 8, 1996; U.S. Patent Application Publication No. 2007/0094148, entitled “METHOD OF LICENSING FUNCTIONALITY AFTER INITIAL TRANSACTION”, and published Apr. 26, 2007; U.S. Patent Application Publication No. 2004/0125397, entitled “LICENSING METHOD FOR USE WITH AN IMAGING DEVICE”, and published Jul. 1, 2004; and U.S. Patent Application Publication No. 2004/0153415, entitled “METHOD OF LICENSING FUNCTIONALITY AFTER INITIAL TRANSACTION”, and published Aug. 5, 2004.

Travelers arriving at an unfamiliar destination often seek information regarding lodging, meals, entertainment, or other services in the area, whether travelling for vacations or business. Often, the traveler initially arrives at an airport, hotel, or rental car business establishment and provision of useful information regarding available options for dining, entertainment, shopping, etc. is most useful at this point in the trip. While hotel concierge personnel, taxi drivers, and/or pre-printed pamphlets are sometimes helpful, such information is often very general and does not necessarily indicate current availability of certain options open to the traveler. Moreover, personal and pre-printed information sources may not be available at all times during the day. Thus, a need remains for improved provision of information to travelers without requiring personnel staffing at initial arrival points.

### BRIEF DESCRIPTION

Document processing device account management systems and methods are disclosed for managing prepaid usage document processing devices configured to allow user initiated advertiser content printing operation at a customer site with no cost to the user, together with facilitation of making reservations and payment in advance for reserved services. The disclosure provides an advertising and promotion printing capability that advantageously allows travelers and other users to print desirable, helpful materials for travel and recreation services at the time of need. Advertisers, such as hotels, car rental agencies, restaurants, shopping centers, entertainment venues, local points of interest, and recreation activity providers may pre-purchase printing capability from a field of printers and other document processing devices registered to customer site accounts at locations available to users, particularly travelers arriving at certain locations. Printable content, such as images, maps, brochures, menus, schedules, driving directions, etc. provided are stored in one or more data stores, and can be viewed and selected by users at an interface, such as participating print kiosks equipped with printers for printing out selected materials at no cost to the traveler. The user in certain embodiments is also prompted to reserve lodgings, tickets, memberships, etc., and can pre-pay for the selected services, with the printed material including reservation numbers, tickets, maps, driving instructions, etc. to aid the traveler with timely information and confirmation of service availability.

One or more aspects of the disclosure relate to a method for managing prepaid usage of one or more document processing devices configured to allow user initiated advertiser content printing operation at a customer site based on available print units applied to the device. The method includes storing account information in a data store for one or more customer accounts, where the customer operates the pre-paid printer(s) for access by users. The account information includes an advertiser available credits value as well as advertiser-specific pricing information for converting account credits available to a particular advertiser to print units for printers registered to the account, and advertiser-content association data that associates particular advertiser content identifiers with particular advertiser identifiers. Upon a request from the customer, credits are added to the advertiser available credits value, such as when an advertiser buys credits from the customer for a given site location. In this regard, the customer can offer credits to any number of advertisers, with the association data being configured to correlate advertisers with the printable content they provide to the customer, and with the customer being free to negotiate different cost rates for different advertisers. When a user at a kiosk or other interface selects a selected advertiser content and a selected printer device, the selected content is correlated with a particular advertiser using the advertiser-content association data, and the account information is updated by decrementing the selected advertiser's available credits value according to the advertiser specific pricing information and a determined job cost for printing the selected advertiser content.

In certain embodiments, the method further provides for facilitating a selected reservation and/or pay-ahead fee associated with the selected content in response to a user selection. In certain embodiments, the determined job cost is received from the selected document processing device as a job cost print units value, and the method further includes determining a job cost account credits value at least partially according to the job cost print units value and the advertiser specific pricing information current at the time of the user selection, as well as decrementing the selected advertiser's available credits value by the job cost account credits value. The method may also include allowing the customer to set the advertiser specific pricing information. Some embodiments of the method, moreover, include providing one or both of a reservation or ticket number for a selected reservation or a confirmed pay-ahead fee amount to the selected document processing device for printing with the selected content.

In other aspects of the disclosure, a non-transitory computer readable medium is provided with computer executable instructions for performing the disclosed methods.

Further aspects of the disclosure provide an account manager system for managing prepaid usage of one or more document processing devices configured to allow user initiated advertiser content printing operation at a customer site based on available print units applied to the device. The account manager system includes a server operative to communicate and exchange data with one or more customer networks and a data store that stores account information for at least one customer account, including an advertiser available credits value as well as advertiser-specific pricing information for converting account credits available to a particular advertiser to print units for printers registered to the account, and advertiser-content association data that associates particular advertiser content identifiers with particular advertiser identifiers. The system also includes an account management component which, upon a request from the customer via a portal, adds credits to the advertiser available credits value indicating an amount of account credits for which a corresponding advertiser has arranged credit with the customer. The account management component is also operative in response to a selection by a user via a user interface of a selected advertiser content and a selected customer document processing device to correlate the selected advertiser content with a particular advertiser using the advertiser-content association data, and to update the account information by decrementing the selected advertiser's available credits value based in whole or in part on the advertiser specific pricing information and a determined job cost for printing the selected advertiser content using the selected customer document processing device. The account management component in certain embodiments is further operative in response to a selection by the user via the user interface of at least one of a reservation associated with the selected content and a pay-ahead fee payment associated with the selected content to facilitate at least one of a selected reservation and a selected pay-ahead fee payment. In certain embodiments, the account manager receives a job cost print units value determined by the selected document processing device and determines a job cost account credits value according to the job cost print units value and the advertiser specific pricing information current at the time of the user selection, and the selected advertiser's available credits value is decremented by the job cost account credits value amount. The account management component in certain embodiments allows the customer to set the advertiser specific pricing information, and may provide either or both of a reservation or ticket number for a selected reservation or a confirmed pay-ahead fee amount to the selected document processing device for printing with the selected content.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter.

FIG. 1 is a system diagram illustrating an exemplary commercial environment with an account manager and various resellers and customer sites networked in which one or more aspects of the present disclosure may be implemented;

FIG. 2 is a system diagram illustrating further details of an exemplary customer networked computing environment with a plurality of user computers with printer device management agents, and with a plurality of printer, scanner, copier, and multi-function type document processing devices that may be managed according to various techniques of the present disclosure;

FIG. 3 is a schematic diagram illustrating exemplary account information stored in the account manager system of FIG. 1;

FIG. 4 is a schematic diagram illustrating further details of an exemplary document processing device registered to an account managed by the account manager system of FIG. 1;

FIG. 5 is a schematic diagram illustrating another embodiment of the account information stored in the account manager system of FIG. 1;

FIG. 6 is a schematic diagram illustrating another embodiment of the document processing device;

FIG. 7 is a flow diagram illustrating exemplary operation of a customer document processing device;

FIG. 8 is a flow diagram illustrating an exemplary process for buying and applying credits to one or more document processing devices;

FIG. 9 is a flow diagram illustrating an exemplary process for updating account information in the account manager system of FIG. 1;

FIG. 10 is a flow diagram illustrating an exemplary process for converting previously applied print units to account credits and for transferring print units from one document processing device to another in a customer account;

FIG. 11 is a flow diagram illustrating an exemplary process for a user to perform printing operations on a public device registered to a vendor account using credits from the user's account via the account management system and techniques of the disclosure;

FIG. 12 is a schematic diagram illustrating an embodiment of the system of FIGS. 1-4 with further details of exemplary account information stored in the account manager system with advertiser specific pricing information, advertiser-content association data, and advertiser available credits information to facilitate user initiated advertiser content printing operation at a customer site; and

FIGS. 13A and 13B provide a flow diagram illustrating an exemplary method for managing prepaid document processing device usage to allow user initiated advertiser content printing operation at a customer site.

### DETAILED DESCRIPTION

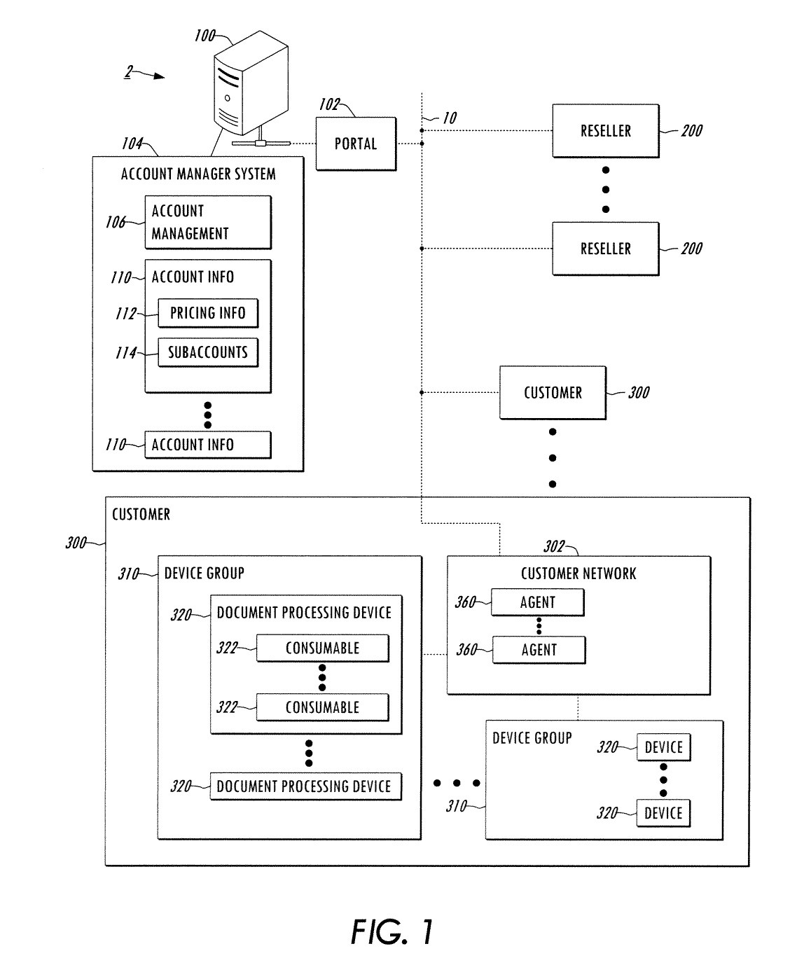

Referring now to the drawings, FIG. 1 shows a networked commercial environment 2 with one or more networks 10 interconnecting a server 100 with one or more resellers 200 and customers 300, where access to an account manager system 104 implemented in the server 100 is accomplished via a portal 102. The server 100 can include a single computer processor or multiple processing elements, and the server 100 may be implemented as a single integrated processor-based structure including memory or may be implemented in distributed fashion including multiple structures, some of which are processor-equipped. The account manager system 104 can be any suitable combination of processor-based hardware, logic, processor-executed software, firmware, or combinations thereof, and may be implemented in a unitary platform (e.g., server 100) or in distributed fashion across multiple processor-equipped devices. In the embodiments, the reseller(s) 200 and customer(s) 300 include reseller and customer networks, respectively, with computers at the reseller(s) 300 and customer(s) 300 being equipped with agent software programs (e.g., customer agents 360 in FIG. 1) operative to allow authorized, secure, encrypted communication between authorized reseller/customer personnel and the account manager system 104 through access via the portal 102. Moreover, the customer agents 360 provide for operation and management tasks between customer document processing devices 320 registered to a customer account and the account management system 104 via the portal 102, and also allow customer to use the agent 360 to communicate with one or more processing devices 320 coupled to a customer network 302. The customer network 302 may include any form of electronic communication network(s) by which the devices 320 can communicate directly or indirectly with the customer computers 330 and/or with the account manager system 104, including without limitation dedicated networks, internet connections, and may include connection of one or more devices 320 with the account manager system 104 via telephony networks (wired and/or wireless or combinations thereof). Thus, the network connection of the devices 320 includes situations in which a primary network connection is inoperative (“network down” condition) with recovery or alternative communications means (e.g., telephone line connection to the devices 320) being provided as an alternative for communication between the devices 320 and the account manager system 104 for validation or other steps.

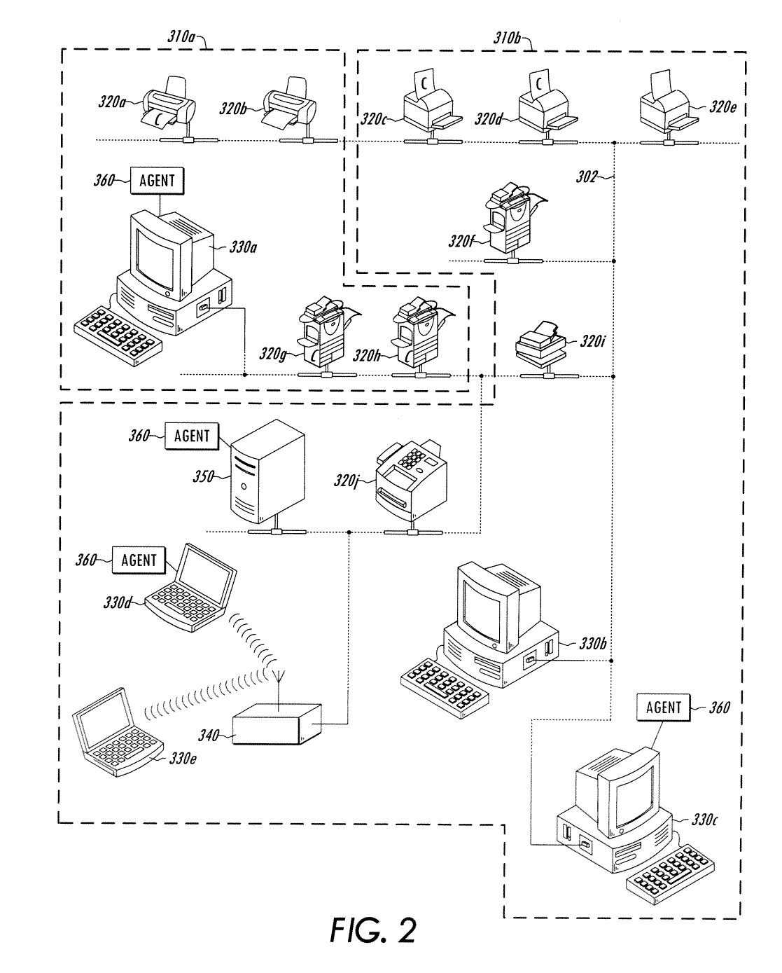

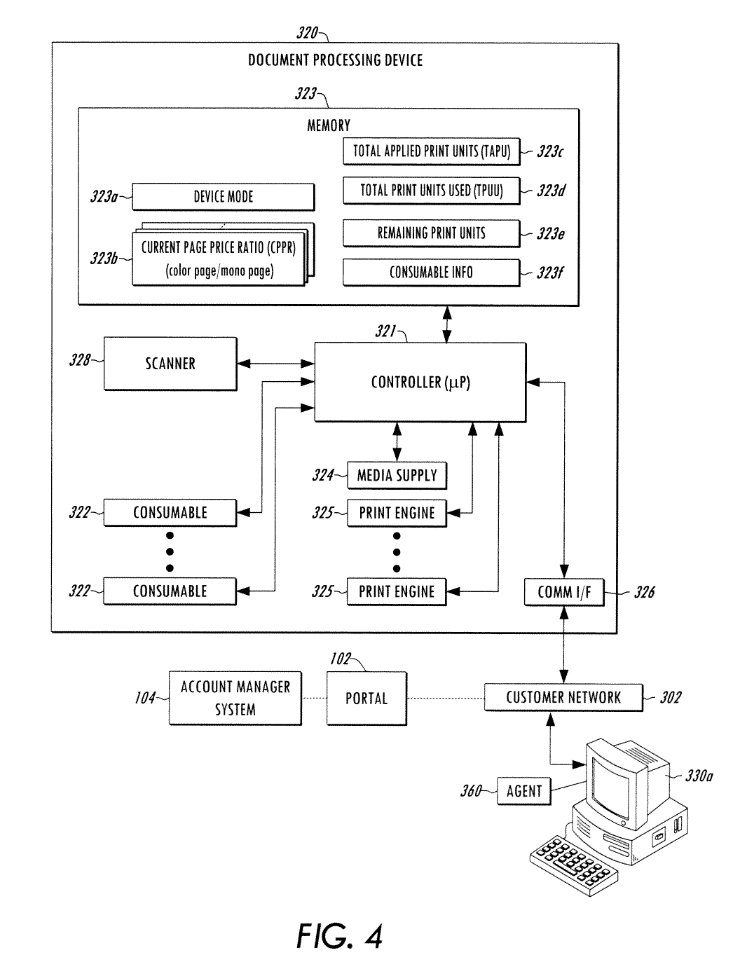

Referring also to FIG. 2, an exemplary distributed customer computing environment is illustrated, including two exemplary logical device groups 310a and 310b, each including one or more computing devices 330, some of which are equipped with agent components 360. In the illustrated environment, the computers 330 are selectively authorized to print or initiate other document processing operations via the devices 320 or predefined subsets of the devices 320, for example, by appropriate password entry & verification via the customer's network 302 and associated network elements and/or by access/usage control features implemented in the devices 320 themselves. The individual groups 310 also include one or more document processing devices 320. The illustrated customer computers 330 and device 320 are operatively coupled via a customer network 302 which may be any suitable form of communications network or interoperative networks. In addition, one or more print servers 50 are coupled with the network 302, where certain portions of the network 302 may be interconnected by cabling or one or more portions may be wireless, and where one or more exemplary computers 330d and 330e are illustrated in FIG. 2 with operative communicative coupling to the network 302 being implemented using a wireless network transceiver interface component 340. Any number of user computers may be operatively coupled to the network 302, including without limitation desktop computers 330a and 330b, laptop computers 330d and 330e, and any number of document processing devices 320 may be coupled with the network 302. Different forms of document processing devices 320 are networked together in this example to provide the user computers 330 with a broad range of document processing options available for a given print job or other task. One or more of the devices 320, moreover, are registered to one or more customer accounts and are operable via the network 302 or by users actuating on-board controls (e.g., buttons, keypads, etc.) for copying and scanning operations and other tasks. The document processing devices 320 may include one or more managed consumables 322 (FIG. 1 and FIG. 4 below) such as non-print media items or materials consumed by the device during document processing operations, including without limitation toner, ink, a replaceable fuser module/component, replaceable imaging units, waste toner bins, transfer belt, or the like.

The exemplary document processing devices 320 shown in FIG. 2 include relatively low throughput externally fed color as well as black and white desktop printers 320a and 320b, respectively, intermediate speed drawer fed color and black and white printers 320c-320e, high volume color as well as black and white printer/scanner/copier (i.e., multi-function) devices 320f-320h, a desktop combination printer/scanner/copier 320i and a combination printer and facsimile machine 320j. Document processing devices 320 may include any device operable to perform one or more document processing functions, including without limitation printers, scanners, copiers, combination scanner-printer-copier machines, and the like. In FIGS. 1 and 2, the customer network 302 and the external network 10 can be arranged in any suitable configuration for example star, ring, bus, tree, mesh, etc. or combinations thereof, and may be a wired network, a wireless network, or combinations thereof, wherein the illustrated customer network 302 of FIG. 2 provides one or more wireless nodes 340 for connectivity for portable laptop computers 330d and 330e through various WiFi or other wireless means.

The devices 320, moreover, are configured to allow normal customer/user initiated operation based on available print units applied to the device 320 in accordance with a customer account administered via the account manager system 104, and may optionally be authorized by the account particulars to perform at some reduced level of functionality even when the applied print units are depleted as discussed further below. By this device functionality, all or at least certain aspects of the actual or expected cost of document processing operation of a given device can be attributed to the customer based on usage, including the initial device cost, cost of consumables 322, costs for servicing (e.g., repairing, troubleshooting, etc.), costs for access to customer support, and other associated costs, rather than being paid up front by the customer.

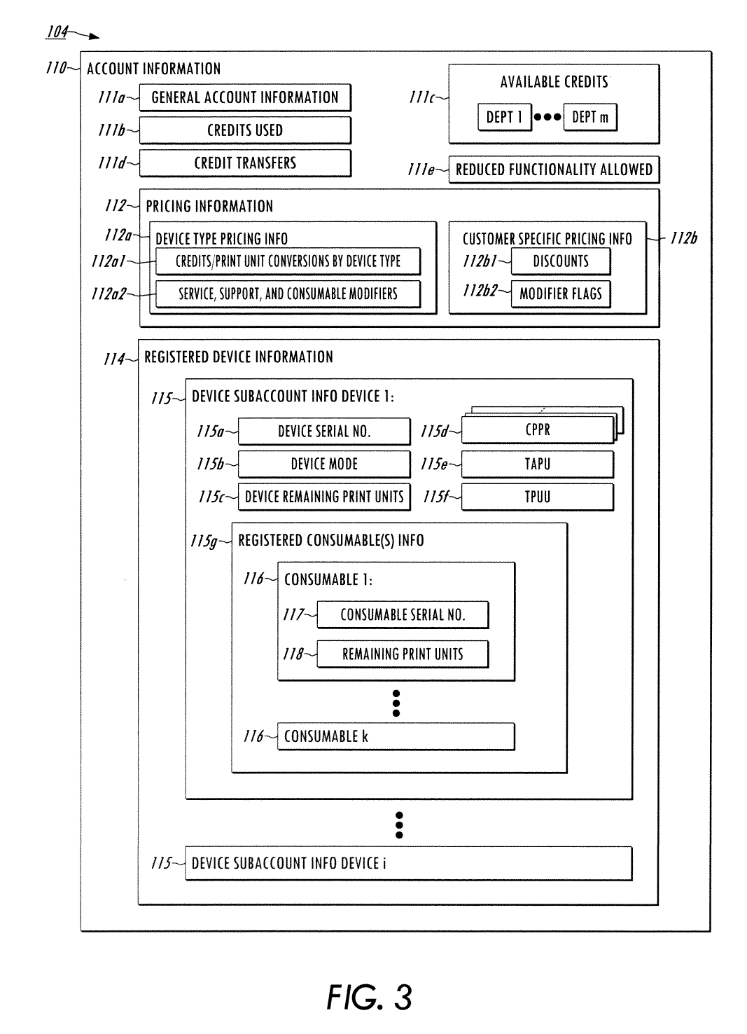

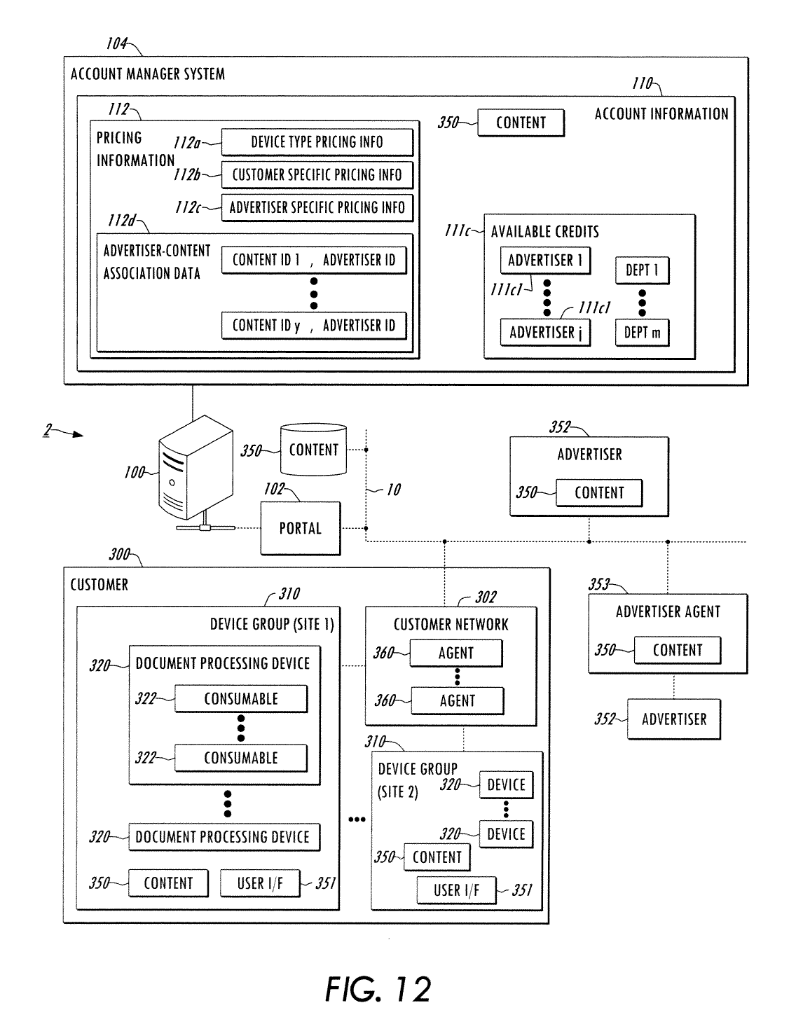

Referring now to FIGS. 1 and 3, usage of the devices 320 is managed via these prepaid accounts by the system 104 using various account information 110 stored in a data store operatively coupled with the server 100, where the data store can be external or internal to the server 100 or combinations of internal and external storage. The account information 110 is stored for a plurality of accounts, for example, a first account for management of prepaid devices 320 of the first device group 310a in FIG. 2 and a second account for devices 320 of the second group 310b, and account information is also stored for multiple different customers, including those customers or ‘vendors’ that register so-called ‘public’ devices 320 as discussed further below in connection with FIG. 11.

As best shown in FIG. 3, the account information 110 for individual accounts includes general account information 111a (e.g., account owner name, address, billing information, authorized users, etc.), a credits used value 111b, for instance, indicating the number of credits that have been previously applied to devices 320 to date from account inception, or in a given predefined period (e.g., year-to-date, etc.), and an available credits value 111c indicating an amount of account credit units currently available to the account for which the corresponding customer has previously paid and which can be applied to one or more devices 320 by customer-initiated request. The available credits information 111c in certain embodiments includes two or more values indicating credits available for different departments or organizational entities within a given customer enterprise. The account information 110 in this embodiment also includes credit transfer information 111d and reduced functionality permission information 111e (described further below in connection with FIG. 3).

The account information 110 for a given account also includes current pricing information 112 including at least one conversion factor for converting account credits available to the account to print units for specific document processing devices 320 registered to the account. The current pricing information 112 for individual accounts in this embodiment includes device type pricing information 112a including at least one price factor 112a1 for each specific document processing device type for converting account credits to print units, and at least one print unit price modifier 112a2 for each of a plurality of different specific document processing device types for increasing the print unit price if a given customer account provides for including one or more additional cost factors for consumables, service, and support in the print unit price. The pricing information 112 also provides customer specific pricing information 112b including discount information 112b1 and modifier flags 112b2 indicating applicability of one or more of the print unit price modifiers 112a2 for the given customer account.

In some embodiments, different discount information 112b1 can be provisioned in the account information 110 for specified document processing devices 320 obtained by a given customer from different resellers 200 and/or for specified document processing devices 320 obtained in different locations or regions, thereby providing reseller flexibility in offering discount incentives to select customers on a global or locality basis. Program provisions can be associated with specific account numbers prior to a reseller offering the accounts for sale to end-customers 300, for example, where the account particulars include account pricing (conversion rates for converting credits into print units), print unit valuation equivalent to typical print images based on coverage, color content, etc., inclusions of service, supplies and media, various incentives, etc. The pre-established account particulars can be associated with a device 320 upon account initiation prior to delivery to the customer 300. In addition, promotional incentives like time frame duration and/or number of printed images can be managed in concert with product usage information associated with and tracked by a customer account, for instance, by tracking use debits and credit balance payments and various particulars of image content.

Account credits are a global currency, which may, but need not, be tied to one or more official government monetary currency value (e.g., N credits per U.S. dollar, etc.) thereby allowing customers to purchase credits for their account(s) using any form of legal payment (e.g., payment obtained and verified electronically via financial institutions, credit organizations, etc.) or direct monetary payments, whether in Dollars, Euros, Yen, etc., with the account manager system 104 being operative to obtain current exchange rate information and make any necessary conversions from a given legal currency payment amount to an account credit amount. Print units, on the other hand, are valued for a given device type and possibly other factors, in terms of units per account credit on a transactional basis at the time of a user request to apply account credits to a particular document processing device, with the valuation being in terms of document processing operations, for instance, one print unit per monochrome page printed by a device 320, 5 print units per printed color page, where a processed ‘page’ as used herein is a single side of a printed media sheet (or a single page of a multi-page document or print job being scanned or operated on by a device 320), such that a device 320 consumes one print unit for printing monochrome images, text, etc., on a single side of an output sheet, consumes 5 print units for printing color images, text, etc. on a single side of a printable medium, and consumes 2 print units to print monochrome images, text, etc. on both sides of a printable media sheet in one example. The application of credits to devices 320, moreover, may be done with respect to integer and/or fractional credits and print units. For example, the customer may specify a given amount of account credits (in whole credits or fractions thereof) to be ‘applied’ to a device 320, and the account manager system may present the customer with the number of converted print units for that device 320, and the device may be adapted to accept fractional print unit amounts or the account management system may perform rounding to provide only integer print unit amounts, with any fractional values being retained as fractional credits in the customer account.

As illustrated in FIG. 3, the account information 110 also includes registered device information 114 with device subaccount information 115 for a plurality of device subaccounts individually associated with a particular document processing device 320 registered by the customer to the account. The device subaccount information 115 for individual device subaccounts includes a device serial number 115a to identify devices 320 registered to the account, a device mode indicator 115b (e.g., including a value indicating toner out, a value indicating whether or not the corresponding device 320 is managed by the system 104, etc.), a remaining print unit value 115c indicating the amount of print units previously applied by the customer to the particular document processing device 320 and currently available to enable the particular document processing device 320 to perform document processing operations, at least one current page price ratio (CPPR) value 115d indicating the number of applied available print units the particular document processing device 320 will consume to print a color page, a total applied print units value (TAPU) 115e, and a total print unit used (TPUU) value 115f indicating the total number of print units used by the corresponding document processing device 320. In addition, the device subaccount information 115 includes registered consumable(s) information 115g including consumable information 116 for one or more consumable individual components 322 operatively associated with the particular document processing device 320 with a consumable serial number or other identifier 117, and a remaining print units value 118 in one example.

In operation, a customer can request an estimate of remaining pages for a specific device 320 registered to the customer's account via an agent 360 and the portal 102, and the account manager system 104 in one embodiment will provide the remaining print units count value 118 in response. In certain implementations, the customer can use the agent to directly obtain this count value from the device itself via the agent 360 and the customer network 302 (e.g., the device 320 will report the current remaining print units value 323e from its internal data in memory 323 as shown in FIG. 4). In certain embodiments, the account manager system 104 may provide the customer with an estimate of the number of remaining mono and color pages printable, for example, by analyzing historical print data (color vs. mono printing) for the particular device 320 and use this in conjunction with the CPPR value 115d to estimate the number of mono and color pages for the customer. The account information 110 can thus accommodate multiple accounts for multiple customers 300, each associated with multiple document processing devices 320 of an unlimited number of different device types, where the devices can have one or more identified consumables 322 for management by the account manager system.

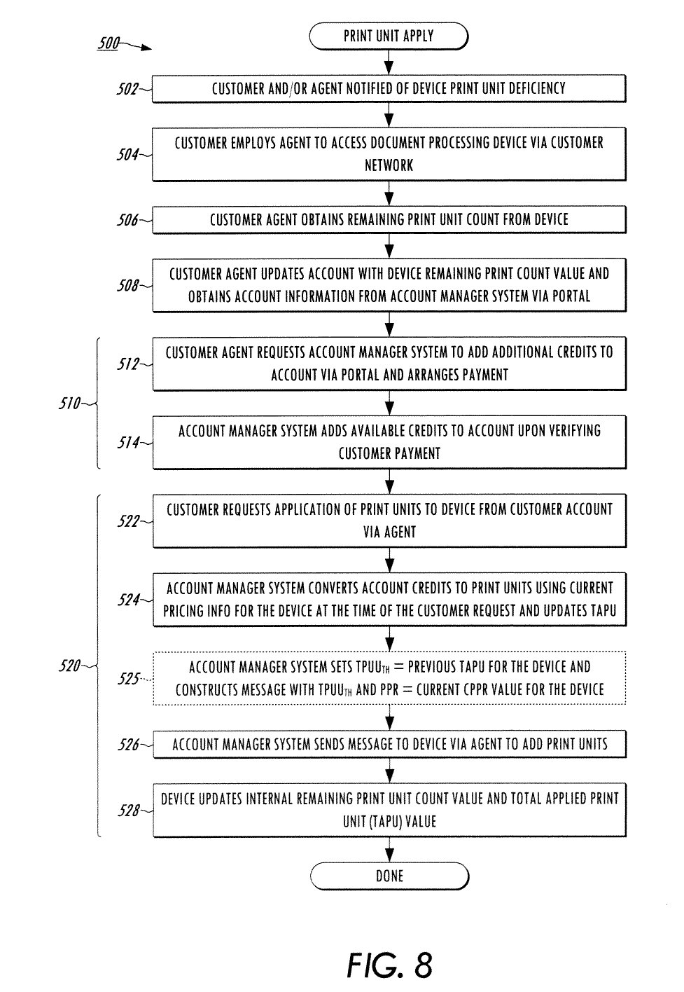

Referring also to FIGS. 4 and 7, an exemplary document processing device 320 is shown in FIG. 4 with a processor-equipped controller 321 and a memory 323, where the device 320 is programmed or provided with suitable processor-executed software, firmware, logic, etc. to controllably provide document processing functions such as printing, faxing, scanning, or combinations thereof and to implement the print unit consumption features of a device registered to an account managed by the account manager system 104. In the illustrated example, a communications interface 326 provides for interfacing the device 320 with the customer network for communicative exchange of data, information, print jobs, etc. with other networked devices, computers, etc., including user computers 330 and agents 360 thereof, and with the account manager system 104 via the portal 102. In addition, the device 320 includes one or more document processing components or systems, such as one or more print engines 325, a scanner 328, media supply 324, and consumable(s) 322, and other such devices (e.g., scanners, sheet feeders, etc., not shown). The memory 323 in this example stores program code and processor-executable instructions for implementing the device functionality, as well as local data to support this operation, including the current device mode information 323a (e.g., corresponding to the mode information 115b in the account information 110 in FIG. 3), one or more current page price ratio value(s) (CPPR) 323b (corresponding to the CPPR value(s) 115d), a TAPU value 323d (corresponding to TAPU value 115e), a TPUU value 323d (corresponding to TPUU 115f), and consumable information 323f obtained from processing elements of the consumable(s) 322 via the controller 321 (corresponding to consumable information 116 in FIG. 3), where the customer agent 360 operates when possible to obtain information from the device 320 (while device 320 is connected to the network 302), and updates the account information of the account manager system 104 accordingly.

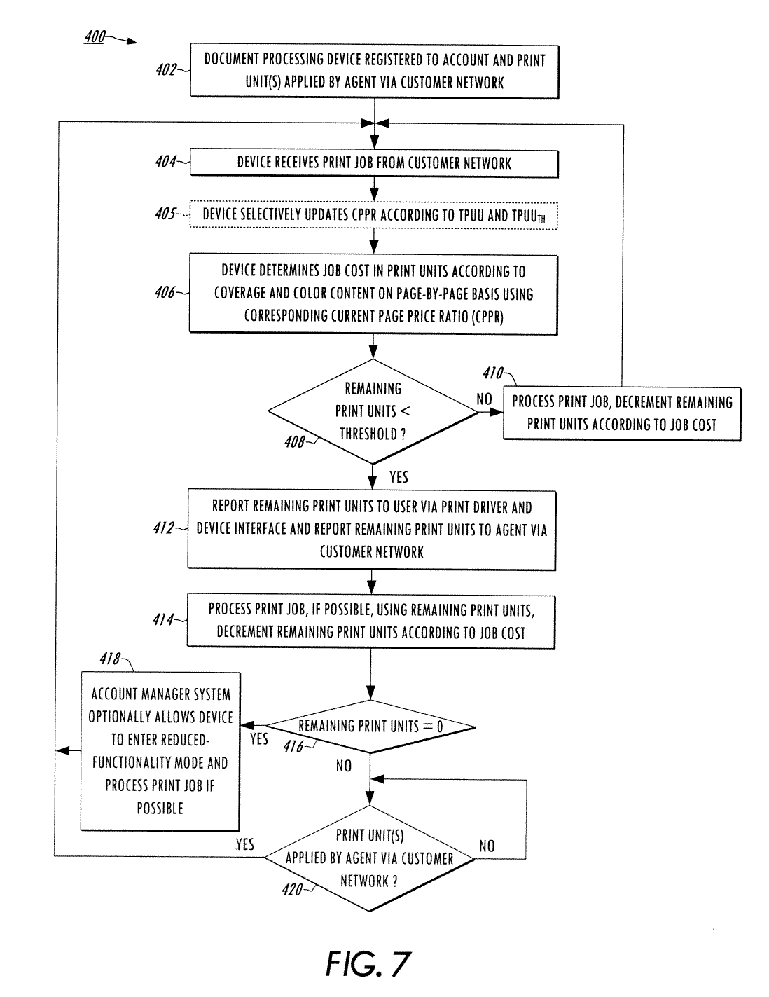

FIG. 7 illustrates exemplary operation of the document processing device 320 in a process 400, in which the device 320 is initialized or registered at 402 to one or more customer accounts by the customer 300 or by a reseller 200, and one or more print units are applied to the device 320 by the customer via a customer agent 360. The example of FIG. 7 is illustrated and described in the context of a printing operation, but similar operation is provided for any other form or type of customer/user-requested document processing operation by a device 320. At 404, the device 320 receives a print job from the customer network 302 (alternatively print job may be part of a copy operation initiated at the device 320 itself, or a print job could be provided by a computer 330 connected to the device 320 even if the device 320 is currently not connected to the network 302). At 405, in one embodiment, the device 320 optionally selects an appropriate current page price ratio (CPPR) from a stack 119 (FIG. 6 below) of page price ratio (PPR) values 119a according to the current value of the total print units used (TPUU) 323d and according to a threshold value TPUU_{TH} 119b in the stack 119. At 406, the device 320 in one embodiment determines the cost for performing the job in terms of print units according to the coverage and color content on a page-by-page basis using CPPR value(s) 323b (FIG. 4), and a determination is made at 408 as to whether the remaining print units (value 323e in FIG. 4) is less than a threshold. In other implementations, the device 320 may determine the job cost based on color content for the entire job (i.e., page cost determined to be ‘color’ for each page if at least one page of the job uses color).

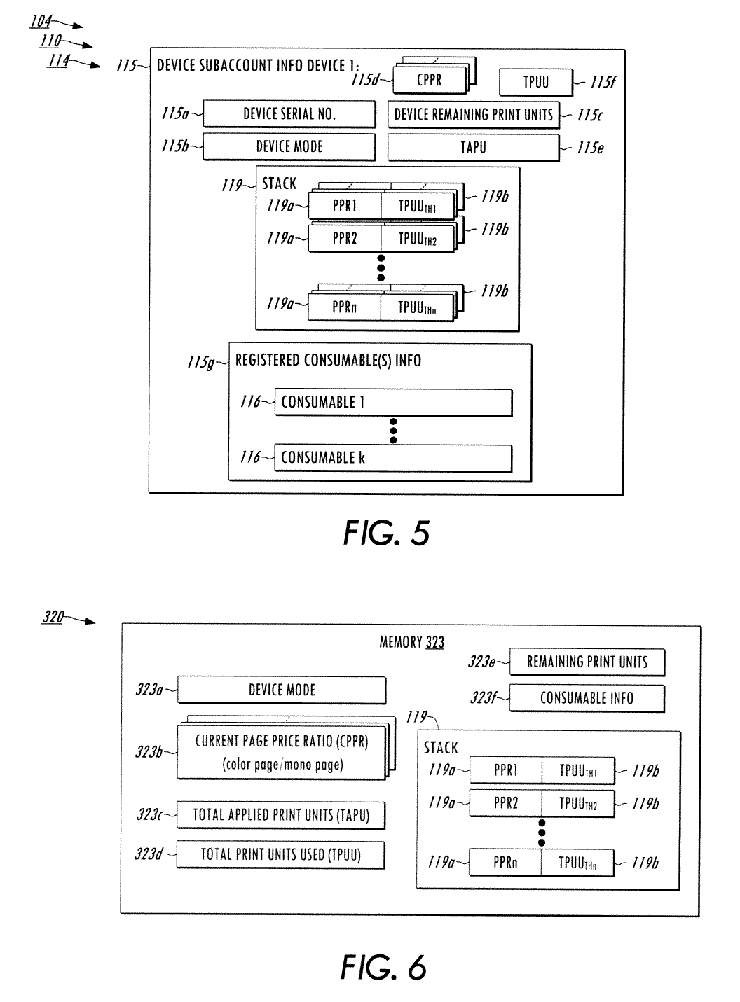

As shown in FIG. 3, the device subaccount information 115 for individual device subaccounts in certain embodiments may include a plurality of different current page price ratios 115d indicating the ratio of the number of applied available print units particular document processing device 320 will consume to print a color page vs. that of a monochrome page, which correspond to different page coverage levels for color pages of documents to be processed. Moreover, the device 320 likewise maintains a corresponding plurality of CPPR values 323b as shown in FIG. 4. In this manner, the account manager system 104 authorizes a specific document processing device 320 to determine page coverage levels for a given color page of a given print job and to consume a corresponding number of available print units to print the given color page according to the corresponding current page price ratio 115d chosen based on the coverage. The CPPR selection for coverage differences can be done in some embodiments on a page-by-page basis. In other embodiments, the device 320 may be configured to determine an average coverage level for all or a subset of the pages of a given jobs and select the corresponding CPPR 115d for the entire job. Moreover, the account manager system 104 may provide the devices 320 with multiple pairs of page price ratio (PPR) values 119a and corresponding threshold values (TPUU_{TH}) 119b with each pair corresponding to a different page coverage value, as shown in FIGS. 5 and 6. In certain embodiments, CPPR may be applied based on printing over a time period, such as days or weeks, or be based on attainment of cumulative totals for a number of pages or jobs.

Returning to FIG. 7, if the required number of print units is available (NO at 408), the print job is processed by the device 320 at 410, and the process 400 returns to await the next document processing task/job at 404. If, however, the remaining number of print units is below the threshold (YES at 412), the device 320 reports the remaining print units (value 323e in FIG. 4) to the user (e.g., via an on-board display and/or via a print driver employed in submission of the print job), and reports the remaining print unit value 323e to an agent 360 via the customer network 302 if currently connected thereto. At 414, the print job is processed by the device 320 (if possible using remaining print units), and the value 323e is decremented according to the cost of the processed job. Otherwise, a determination is then made at 416 as to whether any print units are left in the device 320 (e.g., whether the value 232e has reached zero). If the device is depleted (YES at 416), the device 320 notifies the agent 360, which then notifies the account manager system 104 of the empty status of the device 320, and the account manager system 104 may optionally allow the device 320 to perform at a predetermined reduced level of functionality at 418 (e.g., only print monochrome, only print small jobs, only perform faxing and scanning, etc.) according to the reduced functionality information 111e (FIG. 3). At any point, moreover, authorized customer personnel may apply additional print units to the device at 420 via an agent component 360 and the account manager system 104, after which the unit returns to normal operation. In this manner, the operations of the devices 320 are controlled by the selective application of print units, without which the device 320 will not print (other than the optional account provisions for reduced functionality operation with account-specified restrictions).

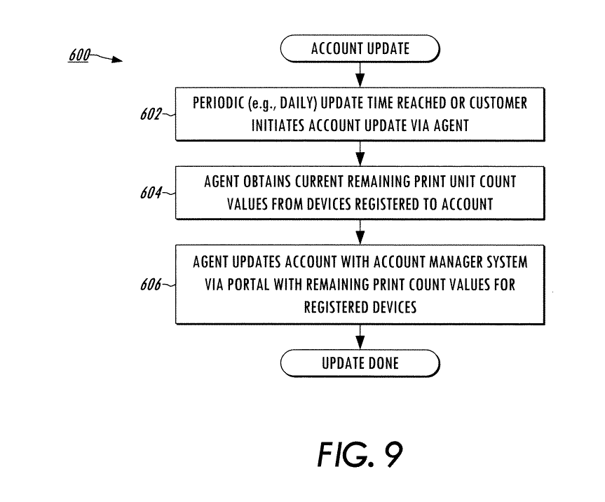

FIG. 8 illustrates an exemplary process 500 by which the account management component 106 of the manager system 104 (FIG. 1) adds credits to an account at 510 and applies print units to a device 320 at 520 upon corresponding request(s) from a customer of a specified account via an authorized agent 360 and the portal 102. In the illustrated process 500, the customer and/or agent 360 are notified at 502 that a particular device 320 has no remaining print units (or that the print unit level is below a threshold value, as discussed in FIG. 7 above). At 504, the customer employs the agent 360 to access the device 320 through the customer network 302, and obtains the remaining print unit count (e.g., value 323e in FIG. 4) from the device 320. At 508, the customer agent 360 accesses the account manager system 104 via the network 10 and the portal 102, updates the corresponding customer account with the remaining print count value (e.g., value 115c in FIG. 3 above), and obtains the corresponding account information 110 for informing the customer of the current account status, such as currently available credits that can be applied to the empty device, current pricing information, etc.

At 510, the account manager system 104, upon customer credit purchase or ‘buy’ request via the agent 360 and portal 102, selectively adds credits to the specified account at a current rate and add a number corresponding to a paid amount of new credits to the available credits value 111c for the specified account if and when the payment for such by the customer is verified. In this example, the agent 360 requests the addition at 512 via the portal 102, and arranges payment, such as via an electronic third party payment mechanism, not shown. At 514, when the account manager system 104 is able to verify the customer payment, it adds available credits to the corresponding customer account, and thus increments the value 111c in the account information 110.

At 520, the account management component 106, upon a request from the customer via the authorized agent 360 and the portal 102, applies print units to a specified document processing device 320 associated with the specified account by converting a number of credits currently available to the specified account into a number of print units according to the specified document processing device 320 and the current pricing information 112 for the specified account at the time of the request. In this example, the customer requests application of print units at 522 to the device using available account credits. At 524, the account manager system 104 converts account credits to print units using the current pricing information 112, and updates the total applied print units (TAPU) value 115e in the corresponding device subaccount information 115. In one embodiment, account manager system 104 updates a stack 119 (FIG. 5 below) at 525 with a new pair of page price ratio (PPR) and threshold values TPUU_{TH} 119a and 119b, respectively, by setting the new TPUU_{TH} to the pervious TAPU value (i.e., the total applied print units (TAPU) value before the current application of further print units). The account manager system 104 sends a message at 526 to the device to add the applied print units (via the agent 360). The device 320 then updates its internal remaining print unit count value 323e and its total applied print units (TAPU) values at 528. In this regard, it is noted that the valuation of the print unit cost is done at the time of application of print units to devices 320, and not when credits are initially bought by the account holder, whereby the system 104 is operative to track sales transactions at the appropriate time when the customer actually purchases the value of the prospective document processing services, which may include consumable, service, support, and other cost factors.

It is further noted that the interaction of the account management component 106 of the system 104, the agent components 360 on the customer computers 330, and the devices 320 can be implemented using multiple messages for requests, confirmations, authorizations, data exchanges, value updates, and other tasks, and the messages can be created and transmitted via any suitable network protocols, etc., and where the messaging is preferably controlled by appropriate authorization, password permission control, encryption, and other techniques to prevent uncontrolled print unit creation without authorization by the account manager system 104, and to guard against unauthorized access to the account information 110. In an alternative implementation, the concept of print unit deficiency notice may be supplemented or supplanted by an arrangement to use a low or out print unit threshold to trigger an automatic purchase of additional print units.

Referring also to FIGS. 5 and 6, the account manager system 104 and the devices 320 in certain embodiments implement an adaptive form of page price ratio adjustment to accommodate changes in the relative cost of printing color versus monochrome pages for a given device 320. For example, a ratio of three (3) may apply for a given document processing device 320 (e.g., according to the device type, the customer account parameters negotiated with the reseller 200, customer region, etc.) at an initial period of time, and this ratio may thereafter change to two (2). The change in the page price ratio may be a negotiated customer-specific arrangement, such as a discount for color printing in a given year or other time period after a certain threshold number of print units are used by that device (e.g., TPUU value 323d in the device memory 323, value 115f in the corresponding device subaccount information 115). In another example, the ratio may change to reflect changes in consumable costs, such as a decrease in color toner cost, with savings passed on to the customer. In order to accommodate such potential changes while minimizing large potential swings in the costs experienced by the customer, the account manager system 104 correlates the ratio with applied print units at the time these are applied to a given device 320, and the device 320 will use the ratio correlated with specific print units as these are expended in performing document processing operations. Thus, for a given device having a large number of print units remaining unused when a page price ratio change occurs, the new ratio will not be applied to the previously applied print units.

To implement this approach, the account manager system 104 and the devices 320 maintain corresponding information stacks 119, where the device subaccount information 115 for a given device 320 in the account manager system 104 includes a stack 119 as shown in FIG. 5, and the device memory 323 also stores a corresponding stack 119 as shown in FIG. 6. As described above and shown at 525 in FIG. 8, each time new print units are applied to a given device 320, the account manager system 104 constructs and sends a message to the device 320 (via the portal 102 and corresponding customer agent 360), including a new stack entry having a page price ratio (PPR) 119a that is set to the present value of the CPPR 115d at the time the print units are applied. The account manager system 104 also sets a threshold TPUU_{TH} 119b in the stack to the previous total applied print units (TAPU) value 115e of the device subaccount information 115. The system 104 then increases the TAPU value 115e to reflect the application of new print units for that device 320 and sends one or more messages to the device 320 to provide the stack entry pair PPR 119a and TPUU_{TH} 119b to the device 320 and to authorize the increase in the device's remaining pint units value 323e for the application operation. The device 320, in turn, updates its stack 119 with the new entry pair PPR 119a and TPUU_{TH} 119b and increases its remaining print units value 323e in the memory 323.

During printing or other document processing in this embodiment, (as discussed above and shown at 405 in FIG. 7) the device 320 compares the present value of the total print units used (TPUU) 323d to the threshold entries 119b in the stack 119 and sets its current page price ratio (CPPR) value 323b to the PPR 119a corresponding to the highest threshold TPUU_{TH} 119b that is less than or equal to the present TPUU value 323d in the memory 323. In this manner, the device 320 consumes print units using the page price ratio applicable at the time the expended print units were applied to the device 320, and only uses the next subsequent PPR when the TPUU reaches or exceeds the corresponding threshold TPUU_{TH} 119b.

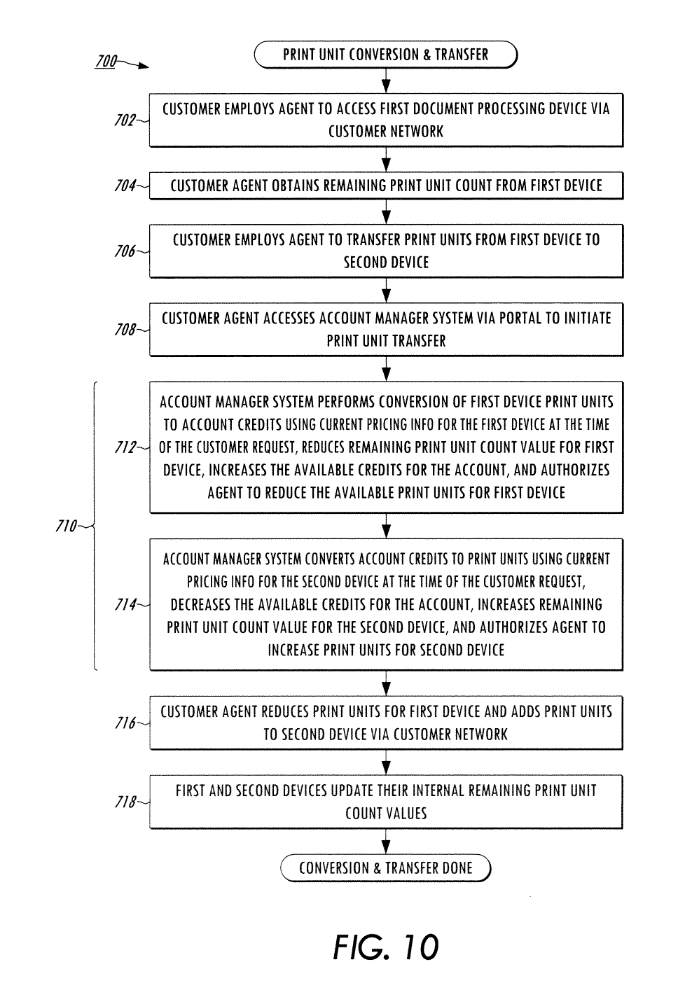

Referring also to FIG. 9, the account management component 106 is further operative to update the account information 110 of a customer account via a process 600. In one embodiment, the updating is periodic, such as daily or hourly, although aperiodic updates are possible, such as through customer initiation at any time, and the updates could be initiated based on other criteria, for example, number of prints, credit balance, etc. In practice, the customer agent component 360 can poll devices 320 connected at a given time to the customer network 302 (although the devices 320 need not be connected to the network 302 to perform document processing operations), and to obtain the device account information, and then forward the gathered data, in whole or in part, to the account manager system 104 via the portal 102. At 602 in FIG. 9, an update is initiated by a predefined periodic update time being reached or by initiation from a customer via an agent 360. At 604, the agent 360 obtains current remaining print unit count value information from devices 320 registered to an account, and the agent 360 updates the system 104 with the values and other data via the portal 102 at 606. The account manager system 104 thus receives updated remaining print unit value(s) 115c for one or more document processing device(s) 320 from a customer via the authorized agent 360 and the portal 102, and updates the registered device information 114 of the account information 110 for the specified account for the document processing device 320.

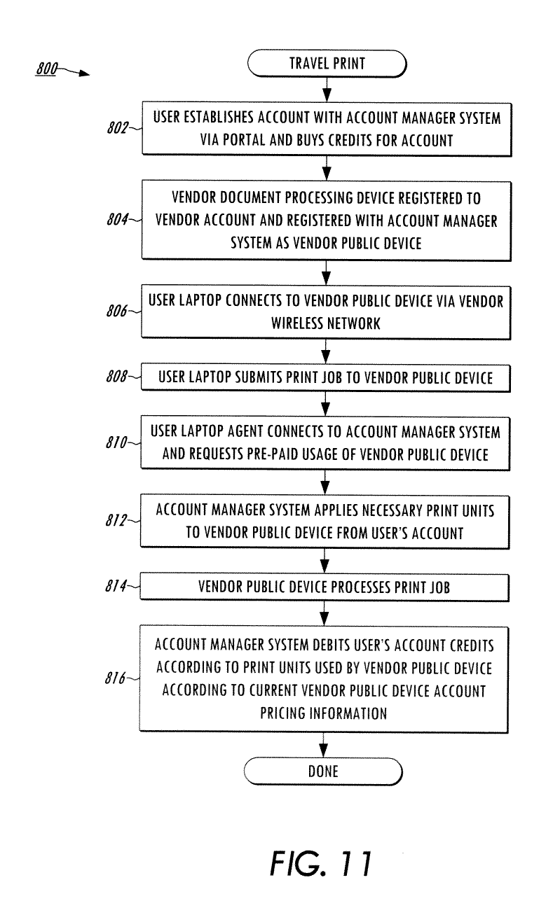

Referring also to FIG. 10, a process 700 is illustrated for converting previously applied print units to account credits and for transferring print units from one document processing device 320 to another in a customer account. In one implementation, the account management component 106 directly converts print units from a first device 320 to print units for the second device 320 using the current pricing information associated with those two devices 320, generally as a single transaction from the customer's perspective, with the first device's print unit count 323e, 115c value being reduced and the second device's value 323e, 115c being increased accordingly without modifying the account credit value 111c. Alternatively, a first transaction is used to transfer print units from the first device and convert these into account credits, and then a second transaction converts account credits and applies print units to the second device, where this form of implementation is illustrated in the embodiment of FIG. 10. At 702, the customer employs an agent 360 to access a first device 320 via the customer network 302 and obtains the remaining print unit count from this device at 704. At 706, the customer uses the agent 360 to transfer print units from the first device 320 to a second device 320 registered to the account. At 708, the agent 360 accesses the account manager system 104 via the portal 102 to initiate the print unit transfer. Any number of devices may be involved in print unit or account credit transfers, as example, from one device split for transfer at some desired ratio to two other devices or credits taken from two devices and applied to a third or to the general account so credits may be later allocated to one or more devices as desired.

At 712, the account manager system 104 converts a number of print units previously applied to the specified first device 320 into a number of account credits available to the specified account according to the specified document processing device 320 and the current pricing information 112 for the specified account at the time of the requested transfer, updating the corresponding available account credits and authorizing the agent 360 to reduce the first device's remaining print unit value 323e (an also updating the print unit value 115c in the stored account information 110). At 714, the account manager system 104 applies print units to the specified second device 320 according to the customer request by converting converted account credits into a number of print units for the second device according to the current pricing information (112) for the specified account at the time of the request, and the corresponding values and account data 110 are updated, with the agent 360 being authorized to apply the print units to the second device. At 716, the agent 360 updates the first and second devices 320, and the devices 320 update their internal count values at 718.

Referring also to FIG. 11, an exemplary process 800 is shown for a user to perform printing operations on a public device 320 registered to a vendor account using credits from the user's account via the account management system 104. This process is implemented via the account manager system 104, with the account management component 106 allowing a user at 802 to establish a user account and to add credits to the user account (e.g., 510 in FIG. 8 above) via a user-authorized agent 360 and a portal 102. At 804, a vendor is allowed to register a particular document processing device 320 to a vendor account as a public device 320 via a vendor-authorized agent 360 and the portal 102. The user at 806 connects to the vendor public device 320 via a vendor network. In one situation, the vendor is a print/copy service with a wireless network in their lobby, and with one or more printers, copiers, fax machines, or other document processing devices 320 designated for public use (by registered users) and registered to the vendor's account. A user, such as a business traveler, having a registered user account with the manager system 104 enters the vendor site with a laptop computer, and accesses the vendor's wireless network and discovers one or more printers available to print a job for the user. At 808, the user submits a print job to a selected vendor printer device 320 (a public device), and an agent component 360 on the laptop computer connects to the account manager system 104 via a portal 102 to request usage of the vendor's public device 320.

The account manager system 104 receives the request at 810, and applies available print units at 812 to the public device 320 (associated with the vendor's account) via a vendor-authorized agent 360 operatively coupled with the public device 320, and the manager system 104 converts a number of credits currently available to the user account into a number of print units according to the public device 320 and the current pricing information 112 for the vendor account at the time of the request. The vendor device 320 then prints the user's job at 814, and the account manager system debits the user's account credits at 816 according to the number of print units used by the vendor public device 320, based on the pricing information established in the vendor's account.

The disclosed methods and account manager systems thus facilitate accounting, provisioning, and controlled usage of a variety of different devices 320 associated with an account, allowing pricing for printing, scanning, faxing, support etc. to be tailored according to the type of service or product model, as well as selective inclusion of costs for consumables 322, service, and support according to specific accounts established for different customers, and for different locations or regions, and any other account-specific factors arranged by a manufacturer implementing the account management system 104 and/or by a reseller 200. The architecture, moreover, allows pricing changes to be made easily by simply updating the account credit-to-print unit conversion information (pricing information 112) at the management system data store. The system 104 also facilitates transfers of prepaid print units from one device to another as well as from a device 320 back to a customer account, thereby enhancing a customer's ability to manage printing devices and users. The customer is also able to selectively include various print unit pricing options, including service, consumables, and/or support, which can vary with the device age and the amount of usage within a given time period, thereby providing better adaptability for valued customers. The plan terms and provisions, moreover, are easily altered by changes to the stored account information 110 by agreement with specific customers. The system also allows consumables, such as toner cartridges, to be transferred from one device 320 to another, with the receiving unit reading the consumable identifier (e.g., serial number) and updating the management system account information accordingly. Moreover, the systems and methods disclosed above allow a specific device 320 to operate at predetermined reduced functionality levels if the device print units become depleted, for instance, where the printer is disconnected from the network 302, thereby allowing the customer to maintain operation until more print units can be applied via the account manager system 104. In certain embodiments, such reduced functionality may include a non-functional state or all disallowance of all functions within one or more function sets (e.g., printing, copying, sorting, etc.).

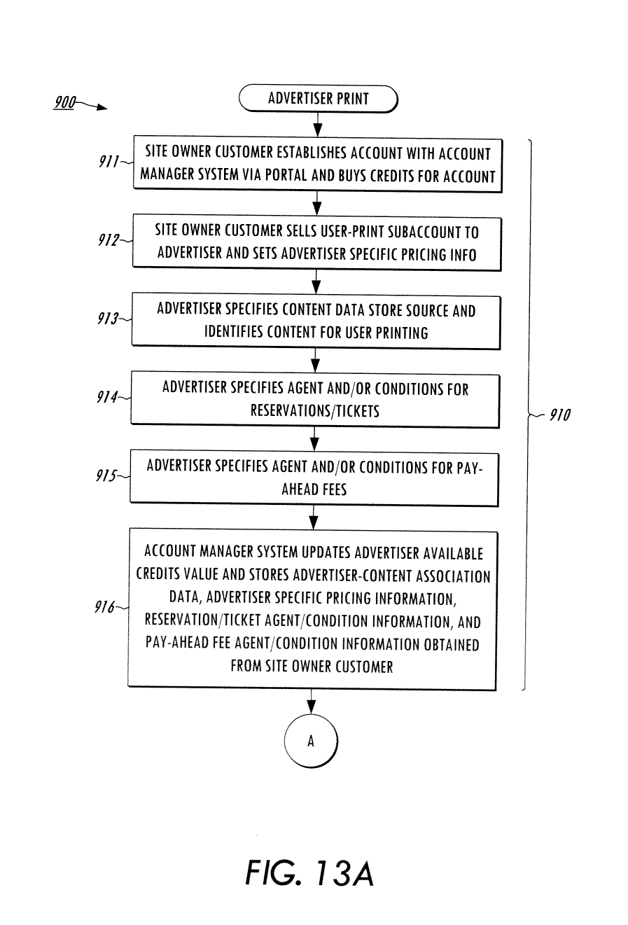

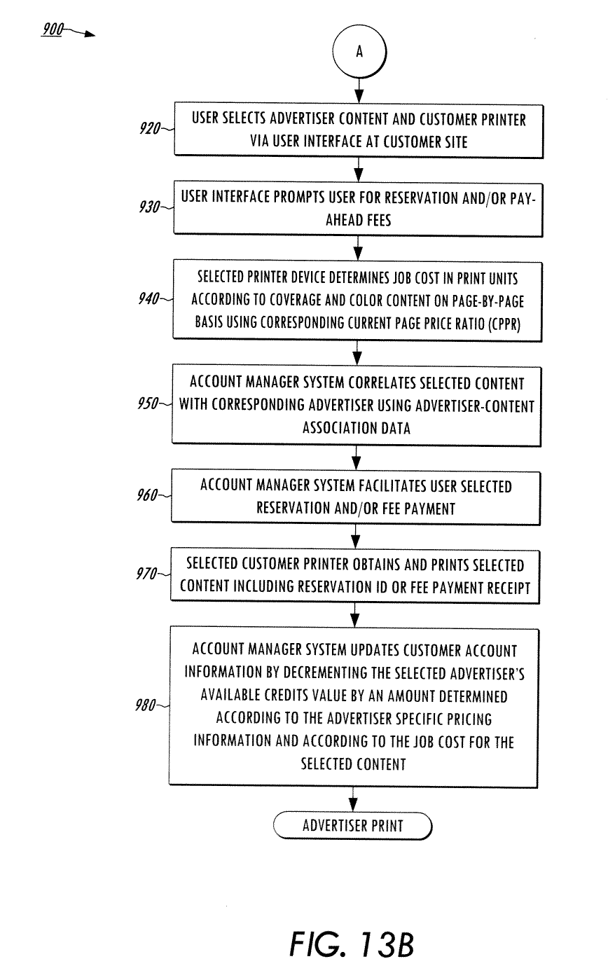

Referring now to FIGS. 12, 13a, and 13b, the account manager system 104 is configured to manage prepaid usage of one or more document processing devices 320 so as to allow user initiated advertiser content printing operation at a customer site 310, an implementation of which is illustrated in FIG. 12. In this example, the account information includes pricing information 112 and available credits values 111c as described above. In addition, the pricing information 112 further includes advertiser specific pricing information 112c as well as advertiser-content association data 112d. Moreover, the account information 110 includes available credits values 111c1 for an integer number j advertisers 352. The account information 110 may optionally include storage of one or more units of advertiser content 350, such as images, text, or other viewable or printable content. Advertiser content may be stored at one or more other locations, for example a content database or data store 350 coupled with network 10, at one or more advertisers 352, at one or more advertiser agents 353, or one or more customer sites 310, as exemplified in FIG. 12. The account manager system 104 in this embodiment allows a customer 300 to make arrangements with one or more advertisers 352 and to allow users to access a user interface 351 at one or more customer sites 310 to view and select for printing, one or more items of advertiser content stored in the data store 350. The advertisers 352 negotiate with the site owner customer 300 such that the advertiser 352 pays the cost of such user printing with the customer 300 being able to separately negotiate different pricing structures for different advertisers 352. The advertisers 352 then provide the content to the customer 300 for storage at the customer site 310 of interest or for storage by the customer 300 elsewhere (e.g., in the account information 110, at a networked data store 350, etc.), and/or the advertisers 352 provide for separate storage of the content 350 themselves or with an advertiser's agent 353 and/or provide necessary location information by which the desired content 350 can be accessed by the customer 300 for later printing by users via the user interface 351.

In the illustrated embodiments, the account management component 106 is programmed or otherwise operationally configured to store one or more advertiser available credits values 111c in the account information 110, where the individual advertiser available credits values 111c1 indicate an amount of account credits currently available for user initiated printing of content items associated with the corresponding advertiser 352 using one or more document processing devices 320 registered to the customer account. In general, these values 111c1 are provisioned when the corresponding advertiser 352 has arranged credit with the customer 300 or otherwise secured payment for such credit, and is updated with further credit extensions, payments, and/or in accordance some other agreed upon credit allocation program, in a matter similar to that described above for customers 300 purchasing account credits. The customer 300 also provisions the account manager system 104 with the advertiser specific pricing information 112c, which includes at least one conversion factor for converting account credits available to a particular advertiser 352 into print units for one or more document processing devices 320 registered to the account. In this matter, the customer 300 can initially provision and later modify pricing structures on an individual advertiser basis. In one simple example, the advertiser specific pricing information 112c may include customer specified discounts, cost modifiers, site specific cost factors, or other information associated with the price the advertiser 352 will pay the customer 300 for allowing users to print the advertiser's content 350. The advertiser 352 and the customer 300 also negotiate the availability, on a site by site basis in certain embodiments, of the advertiser's content 352, and the account manager system stores 104 this as represented by advertiser-content association data 112d. In one possible implementation, the association data 112d includes one or more entries, each of which includes a content ID which identifies a specific content item available in one or more of the content data stores 350, as well as a corresponding advertiser ID which uniquely identifies a particular advertiser 352 with which the customer 300 has arranged for user initiated advertiser content printing operation. In this matter, the advertiser-content association data 112d uniquely associates particular advertiser content identifiers with particular advertiser identifiers, from which the account manager system can later determine the specific advertiser 352 associated with a user selected content item 350.

In operation, a user accesses the system via a user interface 351 located at or otherwise associated with a specific customer site 310. That site 310 may include one or more customer document processing devices 320 operative upon user initiation to print advertiser content 350 selected by the user. In one example, the user is provided with a graphical rendering at the user interface 351 which prompts the user for selection of printable content 350, and which may be menu driven or otherwise operative to present an interactive selection environment to the user. For example, at an airport terminal site 310, the interface 351 may be integrated into a terminal kiosk with one or more user displays and associate touch screen, keyboard, mouse, pointing device, or other input means including without limitation speech recognition apparatus, with the display showing the user a listing or group of content categories from which specific content items may be selected. For instance, the kiosk display may show the user an initial selection screen with various categories listed, such as lodging, dining, entertainment, transportation, etc. Upon selection of one of these categories, further selection display screens can list specific content sponsored by advertiser/providers of such goods or services, such as a listing of various restaurants proximate that specific site 310. Upon selection of one such content item group, the user may then be presented with one or more displayed or described printable content items, such as restaurant menus, maps showing specific geographically and temporally relevant driving directions from the specific site 310 to the selected advertiser location, pictures showing prepared items available at the advertiser 352, pictures showing the restaurant interior and exterior views, text describing hours of operation, pricing, reviews, etc. These content items, moreover, can be temporally relevant, such as driving instructions that take into account current traffic conditions, road closings, etc., images of food items that are the current day's specials, etc., where the account manager system 104 may be operative to adjust available content items based on geographical and/or temporal conditions, and/or the advertiser 352 and/or customer 300 may be operative to do this.

From the presented content items, the user may select one or more for printing via a document processing device (e.g., printer) 320 operatively associated with the site 310, such as a printer located at the terminal kiosk. In this regard, a given site 310 may include more than one document processing devices 320, and the user interface 351 may provide for user selection between two or more such devices 320, or the selection may be by default. In response to such a user selection at the user interface 351 of a selected advertiser content and a selected customer document processing device 320, the interface 351 in this example communicates through the customer network 302 and the external network 10 through the portal 102 with the account manager system 104, which in turn correlates the selected advertiser content item(s) with a particular advertiser(s) 352 using the advertiser content association data 112d. the account manager system 104 updates the account information 110 by decrementing the selected advertiser's available credits value 111c1 based in whole or on part on the advertiser specific pricing information 112c and based on a determined job cost for printing the selected advertiser content using the select customer document processing device 320. In this regard, the selection of a given document processing device 320 may be made by default, for example, where there is only a single printer 320 associated with a particular customer site 310.

Moreover, selection from between a color printer 320 and a monochrome printer 320 may involve different printing costs, which are not charged to the user, but which instead are attributed to the associated advertiser 352, and for which different costs may be negotiated for different advertisers 352. In one embodiment, the selected document processing device 320 is provided with the selected content item or items 350 via the customer network 302, for example, with the account manager system 104 facilitating any routing of the content items and/or provision of location information identifying to the customer 300 or an agent 360 thereof where and how to obtain the selected content 350. The selected content items may then be printed via the selected document processing device 320 for provision to the user, where the printing operation may await provision of further information for inclusion in or with the printed content, such as reservation numbers, receipts, etc., as discussed further below.

The document processing device 320 in certain embodiments also determines the job cost for printing the selected items (e.g., as described at 406 in FIG. 7 above). In one possible implementation, the selected document processing device 320 determines the job cost in terms of print units and provides a job cost print units value (not shown) to the account manager system 104 via an agent 360, the networks 302, 10 and the portal 102. With this, the account manager system 104 determines a job cost account credits value based in whole or in part on the job cost print units value and on the advertiser specific pricing information 112c current at the time of the user selection. In this manner, the cost incurred to the associated advertiser 352 is determined at the time of the user selection, although other embodiments are possible in which the advertiser 352 must convert their account credits into print units for application to one or more specific document processing devices 320 at specific customer sites 310, wherein the cost born by that advertiser 352 in that case is determined at the time of print unit application and thus prior to the time of the user content selection. In the illustrated example, the account manager system 104 decrements the selected advertiser's available credits value 111c1 by the job cost account credits value.

In addition, user interface 351 is operative to provide prompting and other display information allowing a user to secure a reservation, tickets, and/or make seat selections and other associated choices regarding these selections with respect to the services available at the selected advertiser 352. For example, a user arriving at an airport terminal kiosk may select to print driving directions to a particular advertiser restaurant using a selected document processing device 320 at a given kiosk site 310, and the user is then prompted to get a reservation for seating at the selected restaurant. If selected, the user may then be prompted to enter a desired reservation time and number of seats. In another example, the user may select a sports venue advertiser 352, and print out a seating schedule and be prompted to purchase tickets to a sporting event at the advertiser venue 352. The interface 351 is further operative to prompt the user for prepayment (“pay-ahead”) for a selected service at the advertiser 352. In the above examples, for instance, the user may choose to pay-ahead for a particular meal selected from the printed menu and/or may pay-ahead for tickets reserved at the kiosk site 310.

In the illustrated embodiment, the account manager system 104 facilitates one or both of a selected reservation (e.g., seating reservations for restaurants or entertainment venues, lodging reservations for hotels, campgrounds, etc., transportation reservations for rental vehicles, airlines, etc.), and/or a selected pay-ahead fee payment in response to such a selection by the user at the interface 351 by preconfigured interfacing with the advertiser 352 and/or with the selected advertiser's agent 353.

In one embodiment, moreover, the account manager system 104 provides a reservation or ticket number for a selected reservation to the selected document processing device 320 (e.g. via the portal, networks 10, 302, and customer agent 360) for printing on or with the selected content. In this matter, the user's printout of a selected menu from a restaurant, and/or driving directions from the kiosk site 310 to the selected restaurant may include a reservation number that the user can provide to the restaurant host or hostess upon reaching the advertiser 352. In one implementation, the account manager system 104 provides the reservation request information to the advertiser 352 and in turn is provided with the reservation number and associated information to forward to the document processing device 320 selected by the user. In certain embodiments, moreover, the account manager system 104 provides a confirmed pay-ahead fee amount to the selected document processing device 320 for printing a payment receipt on or with the selected content. In this manner, the user is provided with a receipt for any pay-ahead fees paid via the user interface 351.

Referring also to FIGS. 13A and 13B, an exemplarily method 900 is illustrated for managing prepaid usage of at least one document processing device 320 configured to allow user initiated advertiser content printing operation at a customer site 310. The method 900 may be implemented in any configured or programmed processor, such as the server 100 in the illustrated embodiments above. The process 900 begins at 910 where a site owner customer 300 establishes a relationship with one or more advertisers 352 and with the account manager system 104. At 911, the site owner customer 300 establishes an account with the account manager system 104 via the portal 102 and buys account credits for the account. At 912 the site owner customer sells a sub account to an advertiser 352 and sets the advertiser specific pricing information 112c. In certain implementations, the account manager (e.g., such as an equipment manufacturer) and/or an associated reseller 200 may set prices and/or limits to negotiated price structures for printing of advertiser content, or such advertiser prices, cost flexibility parameters, and/or limits can be established by an advertising firm or other third party administering and/or facilitating the advertiser content program. At 913, the advertiser 352 specifies one or more content items that will be provided to users at one or more sites 310 associated with the site owner customer account and may identify a data store source 350 from which the content items are to be obtained. Alternatively or in combination, the advertiser 352 provides the content time(s) to the customer 300 and/or to the account manager system 104 for storage. At 914, the advertiser specifies one or more agents 353 (FIG. 12) as well as conditions for reservations/tickets that will be available at one or more advertiser sites 352. At 915, the advertiser 352 further specifies an agent 353 and/or conditions and information for facilitating pay-ahead fees. At 916, the account manager system 104 provisions the advertiser subaccount by updating the advertiser available credits value 111c1, and by storing advertiser-content association data 112d, advertiser specific pricing information 112c, reservation/ticket agent/condition information, and/or pay-ahead fee agent/condition information obtained from the site owner customer 300.

With the site owner customer account information 110 thus updated, the process 900 continues in FIG. 13B for user initiated advertiser content printer operation at a customer site 310. At 920, a user selects one or more items of advertiser content and a customer printer device 320 (by affirmative selection or by default) via a user interface 351 at a customer site 310. At 930, the user interface 351 prompts the user for reservations and/or for pay-ahead fees. The selected printer device 320 determines a job cost value in print units at 940 according to print job coverage and color content, for example on a page by page basis, using a corresponding current page price ratio (CPPR, e.g. as described above at 406 in connection with FIG. 7). At 950, the account manager system 104 correlates the selected content item or items with a corresponding advertiser 352 using the advertiser-content association data 112d (FIG. 12) and the account manager system 104 facilitates the user selected reservation and/or fee payment at 960. At 970, the selected customer printer device 320 obtains and prints the selected content item or items, including a reservation or fee payment id or receipt. Thereafter at 980, the account manager system 104 updates the customer account information 110 by decrementing the selected advertiser's available credit value 111c1 by an amount determined according to the advertiser specific pricing information 112c and according to the job cost for the selected content.

In accordance with further aspects of the present disclosure, a non-transitory computer readable medium or media is provided, such as a computer memory, a memory within the server 100 or other computer-accessible memory such as a CD-ROM, floppy disk, flash drive, database, server, computer, etc. which has computer executable instructions for performing one or more of the processes disclosed above.

The above described examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software or firmware, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

1. A method for managing prepaid usage of at least one document processing device configured to allow user initiated advertiser content printing operation at a customer site based on available print units applied to the device, the method comprising:
using a computer processor, storing account information in a data store for at least one customer account associated with a customer, the account information comprising:
at least one advertiser available credits value indicating an amount of account credits currently available for user initiated advertiser content printing using at least one document processing device registered to the account for which a corresponding advertiser has arranged credit with the customer,
advertiser specific pricing information including at least one conversion factor for converting account credits available to a particular advertiser to print units for at least one document processing device registered to the account, and
advertiser-content association data associating particular advertiser content identifiers with particular advertiser identifiers;
upon a request from the customer via a portal, using the computer processor, adding credits to the at least one advertiser available credits value indicating an amount of account credits for which a corresponding advertiser has arranged credit with the customer;
in response to a selection by a user via a user interface of a selected advertiser content and a selected customer document processing device, using the computer processor:
correlating the selected advertiser content with a particular advertiser using the advertiser-content association data, and
updating the account information by decrementing the selected advertiser's available credits value based at least partially on the advertiser specific pricing information and a determined job cost for printing the selected advertiser content using the selected customer document processing device.

2. The method of claim 1, further comprising, in response to a selection by the user via the user interface of at least one of a reservation associated with the selected content and a pay-ahead fee payment associated with the selected content, using the computer processor, facilitating at least one of a selected reservation and a selected pay-ahead fee payment.

3. The method of claim 2, further comprising: in response to the selection of the selected advertiser content and the selected customer document processing device, using the computer processor:
receiving the determined job cost from the selected document processing device as a job cost print units value;
determining a job cost account credits value based at least partially on the job cost print units value and the advertiser specific pricing information current at the time of the user selection; and
decrementing the selected advertiser's available credits value by the job cost account credits value.

4. The method of claim 3, further comprising, upon a request from the customer via the portal, using the computer processor, allowing the customer to set the advertiser specific pricing information.

5. The method of claim 4, wherein facilitating at least one of a selected reservation and a selected pay-ahead fee payment comprises providing a reservation or ticket number for a selected reservation to the selected document processing device for printing with the selected content.

6. The method of claim 4, wherein facilitating at least one of a selected reservation and a selected pay-ahead fee payment comprises providing a confirmed pay-ahead fee amount to the selected document processing device for printing a payment receipt with the selected content.

7. The method of claim 3, wherein facilitating at least one of a selected reservation and a selected pay-ahead fee payment comprises providing a reservation or ticket number for a selected reservation to the selected document processing device for printing with the selected content.

8. The method of claim 3, wherein facilitating at least one of a selected reservation and a selected pay-ahead fee payment comprises providing a confirmed pay-ahead fee amount to the selected document processing device for printing a payment receipt with the selected content.

9. The method of claim 2, further comprising, upon a request from the customer via the portal, using the computer processor, allowing the customer to set the advertiser specific pricing information.

10. The method of claim 2, wherein facilitating at least one of a selected reservation and a selected pay-ahead fee payment comprises providing a reservation or ticket number for a selected reservation to the selected document processing device for printing with the selected content.

11. The method of claim 2, wherein facilitating at least one of a selected reservation and a selected pay-ahead fee payment comprises providing a confirmed pay-ahead fee amount to the selected document processing device for printing a payment receipt with the selected content.

12. The method of claim 1, further comprising: in response to the selection of the selected advertiser content and the selected customer document processing device, using the computer processor:
receiving the determined job cost from the selected document processing device as a job cost print units value;
determining a job cost account credits value based at least partially on the job cost print units value and the advertiser specific pricing information current at the time of the user selection; and
decrementing the selected advertiser's available credits value by the job cost account credits value.

13. The method of claim 1, further comprising, upon a request from the customer via the portal, using the computer processor, allowing the customer to set the advertiser specific pricing information.

14. A non-transitory computer readable medium with computer executable instructions for managing prepaid usage of at least one document processing device configured to allow user initiated advertiser content printing operation at a customer site based on available print units applied to the device, the computer readable medium comprising computer executable instructions for:
using a computer processor, storing account information in a data store for at least one customer account associated with a customer, the account information comprising:
at least one advertiser available credits value indicating an amount of account credits currently available for user initiated advertiser content printing using at least one document processing device registered to the account for which a corresponding advertiser has arranged credit with the customer,
advertiser specific pricing information including at least one conversion factor for converting account credits available to a particular advertiser to print units for at least one document processing device registered to the account, and
advertiser-content association data associating particular advertiser content identifiers with particular advertiser identifiers;
upon a request from the customer via a portal, using the computer processor, adding credits to the at least one advertiser available credits value indicating an amount of account credits for which a corresponding advertiser has arranged credit with the customer;
in response to a selection by a user via a user interface of a selected advertiser content and a selected customer document processing device, using the computer processor:
correlating the selected advertiser content with a particular advertiser using the advertiser-content association data, and
updating the account information by decrementing the selected advertiser's available credits value based at least partially on the advertiser specific pricing information and a determined job cost for printing the selected advertiser content using the selected customer document processing device.

15. The computer readable medium of claim 14, further comprising computer executable instructions for, in response to a selection by the user via the user interface of at least one of a reservation associated with the selected content and a pay-ahead fee payment associated with the selected content, using the computer processor, facilitating at least one of a selected reservation and a selected pay-ahead fee payment.

16. An account manager system for managing prepaid usage of at least one document processing device configured to allow user initiated advertiser content printing operation at a customer site based on available print units applied to the device, the system comprising:
a server operatively coupled with a network to communicate and exchange data with one or more customer networks;
a data store operatively coupled with the server to store account information for at least one customer account associated with a customer, the account information comprising:
at least one advertiser available credits value indicating an amount of account credits currently available for user initiated advertiser content printing using at least one document processing device registered to the account for which a corresponding advertiser has arranged credit with the customer,
advertiser specific pricing information including at least one conversion factor for converting account credits available to a particular advertiser to print units for at least one document processing device registered to the account, and
advertiser-content association data associating particular advertiser content identifiers with particular advertiser identifiers; and
an account management component operatively coupled with the data store and the server, and operative upon a request from the customer via a portal, to add credits to the at least one advertiser available credits value indicating an amount of account credits for which a corresponding advertiser has arranged credit with the customer;
the account management component being further operative in response to a selection by a user via a user interface of a selected advertiser content and a selected customer document processing device to:
correlate the selected advertiser content with a particular advertiser using the advertiser-content association data, and
update the account information by decrementing the selected advertiser's available credits value based at least partially on the advertiser specific pricing information and a determined job cost for printing the selected advertiser content using the selected customer document processing device.

17. The account manager system of claim 16, the account management component being further operative in response to a selection by the user via the user interface of at least one of a reservation associated with the selected content and a pay-ahead fee payment associated with the selected content to facilitate at least one of a selected reservation and a selected pay-ahead fee payment.

18. The account manager system of claim 17, the account management component being further operative in response to the selection of the selected advertiser content and the selected customer document processing device to:
receive the determined job cost from the selected document processing device as a job cost print units value;
determine a job cost account credits value based at least partially on the job cost print units value and the advertiser specific pricing information current at the time of the user selection; and
decrement the selected advertiser's available credits value by the job cost account credits value.

19. The account manager system of claim 18, the account management component being further operative upon a request from the customer via the portal, to allow the customer to set the advertiser specific pricing information.

20. The account manager system of claim 18, the account management component being further operative to provide a reservation or ticket number for a selected reservation to the selected document processing device for printing with the selected content.

21. The account manager system of claim 18, the account management component being further operative to provide a confirmed pay-ahead fee amount to the selected document processing device for printing a payment receipt with the selected content.

22. The account manager system of claim 17, the account management component being further operative to provide a reservation or ticket number for a selected reservation to the selected document processing device for printing with the selected content.

23. The account manager system of claim 17, the account management component being further operative to provide a confirmed pay-ahead fee amount to the selected document processing device for printing a payment receipt with the selected content.

24. The account manager system of claim 16, the account management component being further operative upon a request from the customer via the portal, to allow the customer to set the advertiser specific pricing information.
